(19) United States
(12) Patent Application Publication
(10) Pub. No.: US 2023/0192201 A1
(43) Pub. Date: Jun. 22, 2023

(54) VEHICLE HAVING A MOVEABLE BULKHEAD

(71) Applicant: Lear Corporation, Southfield, MI (US)

(72) Inventor: Lea Thomas Smith, Southfield, MI (US)

(73) Assignee: Lear Corporation, Southfield, MI (US)

(21) Appl. No.: 17/555,894

(22) Filed: Dec. 20, 2021

(51) Int. Cl. B62D 33/08; B62D 25/02; B62D 25/06; B62D 25/20; B60J 5/04; B60N 2/01; B60N 2/04

(52) U.S. Cl. CPC B62D 33/08; B62D 25/02; B62D 25/06; B62D 25/20; B60J 5/04; B60N 2/01; B60N 2/04

(57) ABSTRACT

A vehicle having a floor, first and second lateral side body structures, a roof, a rear wall, and a bulkhead. The rear wall extends from the roof and cooperates with the floor to at least partially define an opening. The bulkhead may be moveable in a longitudinal direction of the vehicle.

### TECHNICAL FIELD

This disclosure relates to a vehicle having a moveable bulkhead.

### BACKGROUND

A trailer having a temporary bulkhead is disclosed in U.S. Pat. No. 7,871,229.

### SUMMARY

In at least one embodiment a vehicle is provided. The vehicle may have a floor, a first lateral side body structure, a second lateral side body structure, a roof, a rear wall, and a bulkhead. The floor may extend between a front end and a rear end of the vehicle. The first lateral side body structure may extend from the floor and may include a door. The second lateral side body structure may be spaced apart from and may be disposed opposite the first lateral body structure. The second lateral side body structure may extend from the floor and may include a second door. The roof may be spaced apart from the floor and may be disposed opposite the floor. The roof may extend from the first lateral side body structure to the second lateral side body structure. The rear wall may extend from the first lateral side body structure to the second lateral side body structure and may be longitudinally positioned between the front end and the rear end of the vehicle. The rear wall may extend from the roof and may cooperate with the floor to at least partially define an opening. The bulkhead may be receivable in the opening and may be moveably mounted to the floor. The bulkhead may be moveable along a longitudinal axis with respect to the rear wall. The longitudinal axis may extend between the front end and the rear end.

### BRIEF DESCRIPTION OF THE DRAWINGS

FIG. 1 is a perspective view of an example of a vehicle that has a moveable bulkhead.

FIG. 2 is a fragmentary view of the vehicle of FIG. 1 with the moveable bulkhead in a nominal position.

FIG. 3 is a fragmentary side perspective view of the vehicle of FIG. 1 with the moveable bulkhead in a reclined position.

FIG. 4 is a fragmentary view of the vehicle of FIG. 1 with the moveable bulkhead moved toward the front end of the vehicle.

FIG. 5 is a fragmentary view with the moveable bulkhead in a nominal position and in which a vehicle seat is mounted to the moveable bulkhead.

FIG. 6 is a fragmentary view of the vehicle of FIG. 1 with the moveable bulkhead moved toward the rear end of the vehicle.

FIG. 7 adds a flexible cover and cargo to FIG. 6.

FIG. 8 is a fragmentary view based on FIG. 6 with the vehicle seats facing toward each other.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

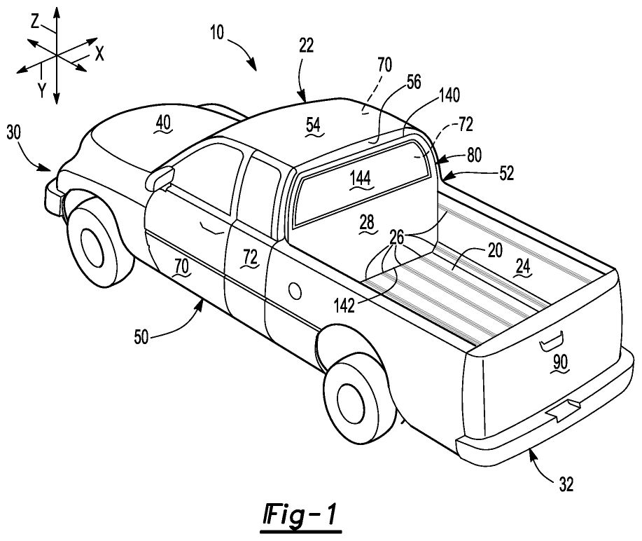

Referring to FIG. 1, an example of a vehicle 10 is shown. The vehicle 10 may be a land vehicle and may be generally configured as a pickup truck. In at least one configuration, the vehicle 10 may include a floor 20, a cabin 22, a bed area 24, one or more guide rails 26, and a bulkhead 28.

For convenience in reference, the terms “longitudinal” and “lateral” may be used to refer to direction or orientation. Longitudinal or longitudinally may be used to designate a fore/aft or front/rear direction or orientation with respect to the vehicle 10. For instance, a longitudinal axis X of the vehicle 10 may extend between the front end 30 and the rear end 32 of the vehicle 10. Lateral or laterally may be used to designate a left/right direction or orientation. For example, a lateral axis Y of the vehicle 10 may be perpendicular to the longitudinal axis X and may extend between the left and right sides or driver and passenger sides of the vehicle 10. A vertical axis Z may be perpendicular to the longitudinal axis X and the lateral axis Y.

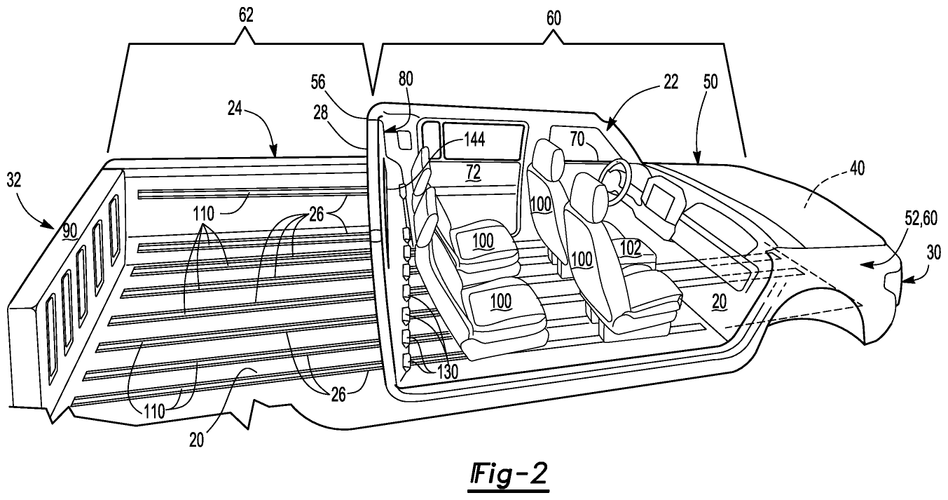

Referring primarily to FIG. 2, the floor 20 may extend between the front end 30 and the rear end 32 of the vehicle 10. For instance, the floor 20 may extend rearward from the cabin 22 into the bed area 24 of the vehicle 10. The floor 20 may also extend forward from the cabin 22 to or toward the front end 30 of the vehicle 10 and into a front trunk 40 of the vehicle 10, if provided. The floor 20 may be configured to extend horizontally and may have a generally flat or planar configuration. Such a configuration may be provided when the vehicle 10 is configured as an electric vehicle in which the batteries and propulsion system of the vehicle 10 are generally disposed underneath the floor 20. One or more guide rails 26 may be provided with the floor 20 as will be discussed in more detail below.

The cabin 22 may be disposed between the front end 30 of the vehicle 10 and the bed area 24. For instance, the cabin 22 may be longitudinally positioned between the front trunk 40 and the bed area 24. The cabin 22 may be partially defined by the floor 20 as well as a first lateral side body structure 50, a second lateral side body structure 52, a roof 54, and a rear wall 56.

The first lateral side body structure 50 may extend between the front end 30 of the vehicle 10 and the rear end 32 of the vehicle 10. The first lateral side body structure 50 may extend from the floor 20 or with respect to the floor 20 in a generally vertical direction. In the configuration shown, the first lateral side body structure 50 is disposed on the driver's side of the vehicle 10; however, it is contemplated that the designations of the first lateral side body structure 50 and the second lateral side body structure 52 may be reversed. One or more guide rails 26 may be provided with the first lateral side body structure 50 as will be discussed in more detail below. In at least one configuration, the first lateral side body structure 50 may include a front portion 60 and a rear portion 62.

The front portion 60 may partially define the cabin 22. The front portion 60 may extend from the rear wall 56 to or toward the front end 30 of the vehicle 10. In addition, the front portion 60 may extend from the floor 20 to the roof 54.

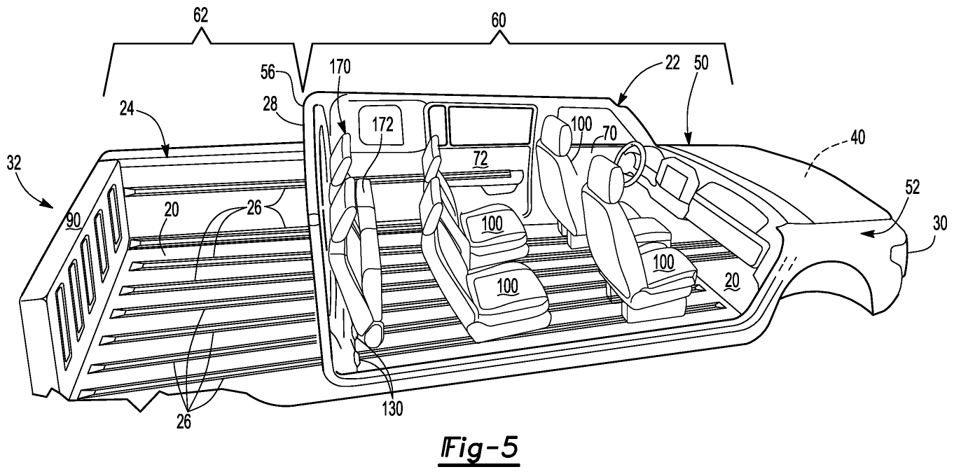

The front portion 60 may be provided in various longitudinal lengths. For instance, the front portion 60 has a greater longitudinal length in the configuration shown in FIG. 5 as compared with the other figures. It is to be understood that the configuration of FIG. 5 can be provided with any of the other figures.

The front portion 60 may include one or more doors. In the configuration shown, the front portion 60 includes a front door 70 and a rear door 72. The front door 70 may be positioned closer to the front end 30 of the vehicle 10 than the rear door 72 is positioned to the front end 30. The rear door 72 may be positioned longitudinally rearward with respect to the front door 70. It is also contemplated that a different number of doors may be provided, such as by adding another door or omitting the rear door 72. Each door may be moveable between an open position and a closed position. In the figures, the front door 70 and the rear door 72 are shown in a closed position in which the front door 70 and the rear door 72 are generally aligned with an adjacent region of the first lateral side body structure 50. The front door 70 and the rear door 72 may be pivotable to an open position in a manner known by those skilled in the art.

The rear portion 62 may partially define the bed area 24. The rear portion 62 may extend from the rear wall 56 to or toward the rear end 32 of the vehicle 10. The rear portion 62 may have a shorter height than the front portion 60. For instance, the rear portion 62 may extend upward but may not extend to the roof 54 in one or more configurations. The rear portion 62 may or may not be contiguous with the front portion 60.

Referring primarily to FIGS. 1 and 2, the second lateral side body structure 52 may be disposed opposite the first lateral side body structure 50. As such, the first lateral side body structure 50 may be spaced apart from the second lateral side body structure 52. In at least one configuration, the second lateral side body structure 52 may be generally configured as a mirror image of the first lateral side body structure 50. Thus, the second lateral side body structure 52 may be provided with one or more guide rails 26 and may include a front portion 60, a rear portion 62, and one or more doors as previously discussed.

Referring to FIG. 1, the roof 54 may be disposed opposite the floor 20. As such, the roof 54 may be disposed above and may be spaced apart from the floor 20. The roof 54 may extend laterally from the front portion 60 of the first lateral side body structure 50 to the front portion 60 of the second lateral side body structure 52. The roof 54 may also extend from the rear wall 56 toward the front end 30 of the vehicle 10. For instance, the roof 54 may generally extend from the rear wall 56 to a windshield of the vehicle 10.

Referring primarily to FIGS. 1 and 2, the rear wall 56 may be stationary and may be fixedly positioned with respect to the floor 20. The rear wall 56 may be longitudinally positioned between the front end 30 and the rear end 32 of the vehicle 10. For example, the rear wall 56 may be disposed proximate the rear of the cabin 22. The rear wall 56 may extend laterally from the first lateral side body structure 50 to the second lateral side body structure 52. For instance, the rear wall 56 may extend from the front portion 60 of the first lateral side body structure 50 to the front portion 60 of the second lateral side body structure 52. The rear wall 56 may also extend from the roof 54 to or toward the floor 20. For instance, the rear wall 56 may extend downward from the roof 54 toward the floor 20 and may cooperate with the floor 20 to at least partially define an opening 80. In at least one configuration, the floor 20, the first lateral side body structure 50, the second lateral side body structure 52, and the rear wall 56 may cooperate to define the opening 80. Moreover, it is contemplated that the rear wall 56 may not extend to the floor 20 or that the rear wall 56 may not extend to the floor 20 where the opening 80 is provided. The opening 80 may be configured as a through hole that may be sized to receive the bulkhead 28.

The bed area 24 may be disposed longitudinally rearward of the rear wall 56. For instance, the bed area 24 may generally extend between the rear end 32 of the vehicle 10 and the rear wall 56. The bed area 24 may be at least partially defined by the rear portion 62 of the first lateral side body structure 50, the rear portion 62 of the second lateral side body structure 52, and a tailgate 90.

The tailgate 90 may be disposed proximate the rear end 32 of the vehicle 10. The tailgate 90 may extend laterally between the rear portion 62 of the first lateral side body structure 50 and the rear portion 62 of the second lateral side body structure 52. In addition, the tailgate 90 may be pivotally attached to the vehicle 10 and may be moveable between an open position and a closed position. The tailgate 90 may be generally aligned with the floor 20 when in the open position. The tailgate 90 may extend vertically upward when in the closed position. The tailgate 90 is shown in the closed position in the figures.

Referring primarily to FIG. 2, one or more guide rails 26 may be provided with the vehicle 10. A guide rail 26 may facilitate mounting and movement of various components, such as the bulkhead 28, one or more vehicle seats 100, one or more console units 102, or the like. In addition, a guide rail 26 may facilitate anchoring of cargo. A guide rail 26 may extend longitudinally or in a longitudinal direction. In at least one configuration, a plurality of guide rails 26 may be provided that may be disposed substantially parallel to each other and that may be spaced apart from each other.

A guide rail 26 may have any suitable configuration. For instance, a guide rail 26 may have a hollow cross-sectional configuration that may have an opening or elongated slot 110 that may be provided on a visible side of guide rail 26. The elongated slot 110 may extend longitudinally. For instance, the elongated slot 110 may extend longitudinally from one end of the guide rail 26 to and opposite end of the guide rail 26. The elongated slot 110 may receive a component that facilitates mounting to the guide rail 26, such as a clamp, hook, latch mechanism, or the like. A guide rail 26 may be provided as a unitary one-piece component or may be provided as separate pieces that are aligned with each other.

Guide rails 26 may be provided in various locations. For example, one or more guide rails 26 may be provided with the floor 20. Alternatively or in addition, one or more guide rails 26 may be provided with the first lateral side body structure 50, the second lateral side body structure 52, or both.

In the configurations shown, six guide rails 26 are provided with the floor 20; however, it is contemplated that a greater or lesser number of guide rails 26 may be provided. The guide rails 26 that are provided with the floor 20 may extend into the cabin 22 and the bed area 24. As such, the guide rails 26 may extend through the opening 80. One or more guide rails 26 may also extend into the front trunk 40, if provided. In the configurations shown, the two guide rails 26 disposed closest to the longitudinal center line of the vehicle 10 extend into the front trunk 40, thereby allowing the console unit 102 to be moved under the dashboard and into or out of the front trunk 40. The other guide rails 26 may facilitate mounting and longitudinal positioning of a vehicle seat 100. In the figures, the vehicle seats 100 are primarily illustrated as being bucket seats; however, it is also contemplated that a vehicle seat 100 may be configured as a bench seat that may provide seating positions for multiple seat occupants. Some or all of the guide rails 26 may facilitate mounting and positioning of the bulkhead 28.

In the configurations shown, two guide rails 26 are provided with the first lateral side body structure 50 and the second lateral side body structure 52; however, it is contemplated that a greater or lesser number of guide rails 26 may be provided. It is also contemplated that the first lateral side body structure 50 and the second lateral side body structure 52 may be provided with equal or unequal numbers of guide rails 26. One or more guide rails 26 that are provided with a lateral side body structure 50, 52 may extend into the cabin 22, the bed area 24, or both. Thus, the guide rail 26 may extend through the opening 80. The guide rails 26 that are provided with a lateral side body structure 50, 52 may facilitate mounting and longitudinal movement or longitudinal positioning of the bulkhead 28.

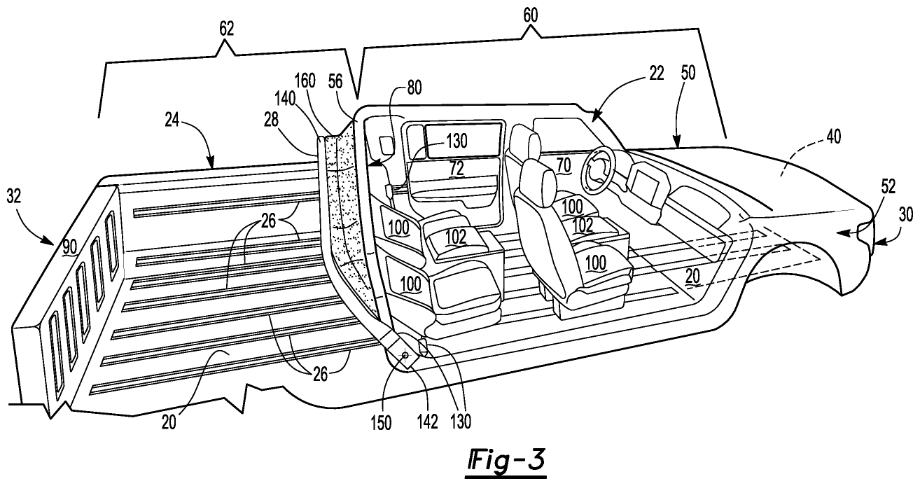

A guide rail 26 of a lateral side body structure 50, 52 may be provided with the door or may be part of the door. In FIG. 2, a guide rail 26 is illustrated as being provided with the rear door 72 but not the front door 70. It is also contemplated that a guide rail 26 of a lateral side body structure 50, 52 may also be provided with the front door 70 or may not be provided with any door as shown in FIG. 3. It is to be understood a guide rail 26 may be provided with a door in FIG. 3.

The bulkhead 28 may help separate the cabin 22 and the bed area 24. The bulkhead 28 may have any suitable configuration. In the configuration shown, the bulkhead 28 is configured as a panel that may extend in a generally vertical direction between a top end 140 and a bottom end 142, which are best shown in FIG. 1. The top end 140 may be disposed proximate the rear wall 56 and/or the roof 54 when the bulkhead 28 is in a nominal position in which the bulkhead 28 is received in the opening 80 and extends in a generally vertical direction. The bottom end 142 may be disposed opposite the top end 140. The bottom end may be disposed proximate the floor 20.

The bulkhead 28 may be sized to fit within the opening 80. In addition, the bulkhead 28 may be sized to pass through the opening 80. The bulkhead 28 may be provided with a window 144 that may facilitate rearward visibility or visibility toward the rear end 32 of the vehicle 10. The bulkhead 28 may or may not support other components such as a vehicle seat or storage compartment as will be discussed in more detail below

Referring primarily to FIG. 2, the bulkhead 28 may be moveable in a longitudinal direction to alter the size, volume, or effective length of the cabin 22 and the bed area 24. The bulkhead 28 may be mounted to one or more guide rails 26. For instance, the bulkhead 28 may be mounted to one or more guide rails 26 that are provided with the floor 20, one or more guide rails 26 that are provided with the first lateral side body structure 50, one or more guide rails 26 that are provided with the second lateral side body structure 52, or combinations thereof. The bulkhead 28 may be mounted to a guide rail 26 with a coupling 130. The coupling 130 may have any suitable configuration. For example, a coupling 130 may be configured as a clamp, hook, latch, locking pin, or the like. The coupling 130 may be actuatable between an engaged position and a disengaged position. The coupling 130 or a portion thereof may be secured to a guide rail 26 in the engaged position. The coupling or a portion thereof may be moveable with to a guide rail 26 when in the disengaged position. As such, the coupling 130 the bulkhead 28 to move with respect to the guide rail 26 when in the disengaged position. It is contemplated that the bulkhead 28 may be supported without coupling the bulkhead 28 to a guide rail 26 that may be provided with the roof 54.

The bulkhead 28 may be moveable along the guide rails 26. For instance, the bulkhead 28 may be positionable such that the bulkhead 28 is received in the opening 80 as is shown in FIG. 2. The bulkhead 28 may also be moveable or slidable out of the opening 80. For instance, the bulkhead 28 may be moveable toward the front end 30 of the vehicle 10, toward the rear end 32 of the vehicle 10, or combinations thereof. As such, the bulkhead 28 may be moveable longitudinally or along the longitudinal axis X with respect to the rear wall 56. Providing a moveable bulkhead 28 may allow the vehicle 10 to be reconfigured to serve various purposes and fulfill various user needs. Some possible configurations are best understood with reference to FIGS. 2-8.

Referring to FIG. 2, a configuration is shown in which the bulkhead 28 is received in the opening 80 and is substantially aligned with the rear wall 56. This may be referred to a nominal position. The bulkhead 28 may seal against the rear wall 56 to help isolate the cabin 22 from noise and the surrounding environment when in the nominal position.

Referring to FIG. 3, a configuration shown in which the bulkhead 28 is pivoted with respect to the floor 20 and the rear wall 56. For example, the bulkhead 28 may be rotatable or pivotable about an axis 150. The axis 150 may be disposed near the floor 20. Pivoting may be accomplished in various ways. As one example, the bulkhead 28 may be pivotally coupled to the couplings 130 that couple the bulkhead 28 to the guide rails 26 and the floor 20. These couplings 130 may be held in their respective engaged positions or in a stationary longitudinal position on a guide rail 26 of the floor 20 while couplings 130 that couple the bulkhead 28 to one or more guide rails 26 that are provided with lateral side body structures 50, 52 may be disengaged, moved toward the rear end 32 of the vehicle 10, and then reengaged. Movement of the couplings 130 that are associated with the guide rails 26 of the lateral side body structures 50, 52 may rotate the bulkhead 28 about the axis 150 in a counterclockwise direction from the perspective shown from the nominal position shown in FIG. 2 to a reclined position shown in FIG. 3. The top end 140 of the bulkhead 28 may be positioned further rearward or closer to the rear end 32 of the vehicle 10 than the bottom end 142 of the bulkhead 28 when the bulkhead 28 is in the reclined position. The reclined position shown in FIG. 3 is an example. As such, the bulkhead 28 may be rotated about the axis 150 to a greater or lesser degree than that shown.

It is also contemplated that the bulkhead 28 may be inclined (e.g., rotated in a clockwise direction about the axis 150 with respect to the nominal position) rather than reclined and that the bulkhead 28 may be reclined or inclined when the bulkhead 28 is in a different longitudinal position than that shown.

It is also contemplated that the bulkhead 28 may be reclined or inclined by holding the couplings 130 that couple the bulkhead 28 to one or more guide rails 26 that are provided with the lateral side body structure 50, 52 in their respective engaged positions or in a stationary position while the couplings 130 that couple the bulkhead 28 to one or more guide rails 26 that are provided with the floor 20 may be disengaged, moved, and then reengaged to tilt or pivot the bulkhead 28.

A flexible cover 160 may extend from the bulkhead 28 to a part of the vehicle 10 that may define the cabin 22, such as the front portion 60 of the first lateral side body structure 50, the front portion 60 of the second lateral side body structure 52, the rear wall 56, the roof 54, or combinations thereof. The flexible cover 160 may be configured to expand, stretch, unfold, unroll, or bend when the bulkhead 28 is moved from the nominal position to the reclined position. As such, the flexible cover 160 may help isolate the cabin 22 from the surrounding environment when the bulkhead 28 is reclined. Reclining the bulkhead 28 may increase the size or volume of the cabin 22. In addition, reclining the bulkhead 28 may allow vehicle seats 100 that are located adjacent to the bulkhead 28 to recline further than when the bulkhead 28 is in the nominal position.

In at least one configuration, console units 102 may be provided between the front row vehicle seats 100, the second row vehicle seats 100, or both. The console units 102 may be mounted to the same guide rails 26 if multiple console units are provided.

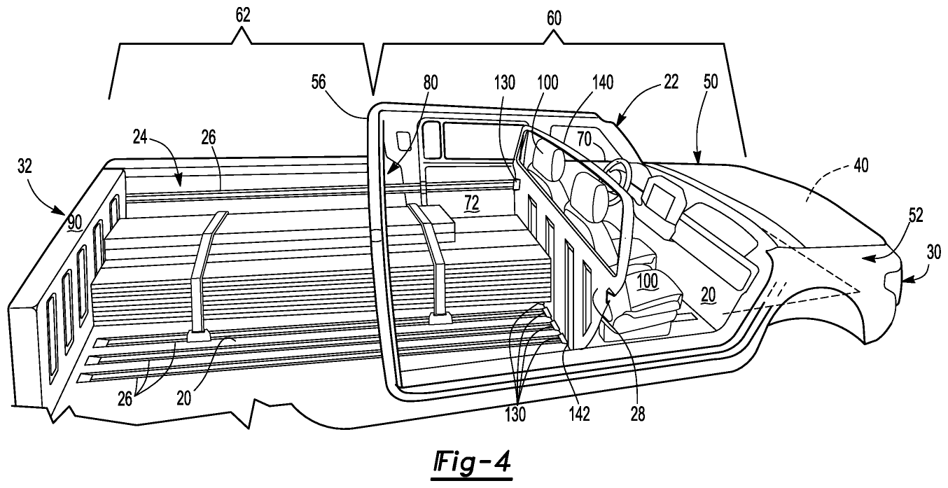

Referring to FIG. 4, a configuration is shown in which the bulkhead 28 is moved longitudinally through the opening 80 and toward the front end 30 of the vehicle 10 to extend the effective length of the bed area 24. The bulkhead 28 may be disposed closer to the front end 30 of the vehicle 10 than the rear wall 56 is disposed to the front end 30 of the vehicle 10 in such a position. As compared to the configuration in FIG. 2, one or more vehicle seats 100 may be decoupled from associated guide rails 26 and removed or relocated before moving the bulkhead 28. For instance, a rear vehicle seat 100 that is disposed behind a front seating row or front vehicle seat 100 may be removed or relocated. The bulkhead 28 may slide along a portion of one or more guide rails 26 that are provided with a door, such as a rear door 72, depending on how far the bulkhead 28 is moved forward. In the position shown in FIG. 4, the bulkhead 28 may be connected to or mounted to a rear door 72 and the rear door 72 may be disposed in its closed position. Thus, the rear door 72 may not be moveable to its open position when the bulkhead 28 is aligned with and operatively connected to or mounted to the rear door 72. It is contemplated that the bulkhead 28 may not be moveable to the position shown when a rear door 72 is not closed.

Referring to FIG. 5, a configuration is shown in which a vehicle seat 170 is mounted to the bulkhead 28. The vehicle seat 170 may be a second seating row or third seating row that may be disposed behind one or more other rows of vehicle seats 100. The vehicle seat 170 may be mounted on a side of the bulkhead 28 that may face toward the front end 30 of the vehicle 10. As such, the vehicle seat 170 may be moveable with the bulkhead 28. The vehicle seat 170 may be longitudinally positioned rearward of the rear wall 56 when the bulkhead 28 is moved rearward, such as when the bulkhead 28 is disposed adjacent to the tailgate 90. The seat bottom 172 of the vehicle seat 170 may be foldable between an unfolded position and a folded position. In the unfolded position, the seat bottom 172 of the vehicle seat 170 may extend toward the front end 30 of the vehicle 10 and may be disposed in a generally horizontal position. In the folded position, the seat bottom 172 may be folded upward toward the roof 54 of the vehicle 10 to provide additional storage space. An example of the folded position shown in FIG. 5. It is also contemplated that the seat back may be mounted to the bulkhead 28 and may be reclined or inclined by pivoting or tilting the bulkhead 28 as previously discussed.

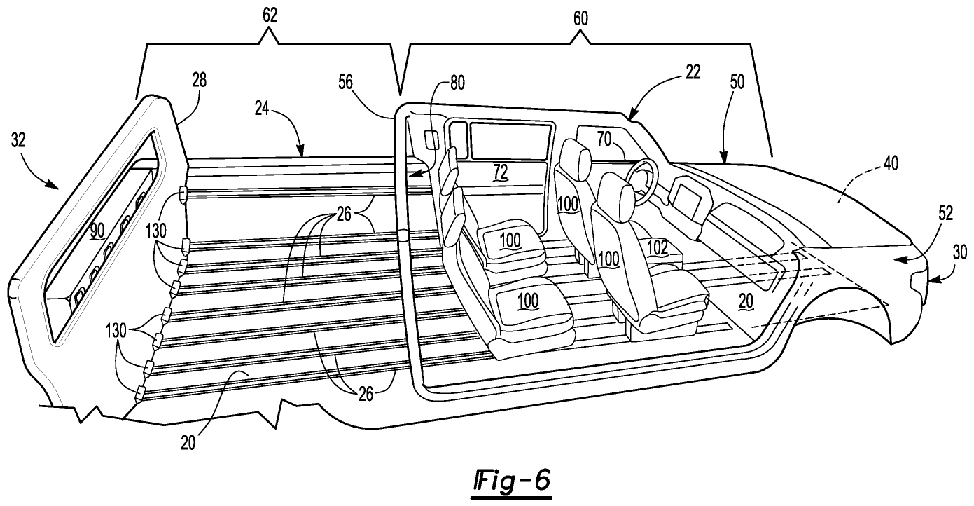

Referring to FIG. 6, a configuration is shown in which the bulkhead 28 is moved longitudinally through the opening 80 and toward the rear end 32 of the vehicle 10. In FIG. 6, the bulkhead 28 is disposed proximate the tailgate 90; however, it is to be understood that the bulkhead 28 may be positionable at an intervening position that may be located closer to the rear wall 56. The bulkhead 28 may be spaced apart from the rear wall 56 and may not be disposed in the opening 80. In this configuration, the cabin 22 may be open to the surrounding environment, and one or more vehicle seats 100 may be moveable through the opening 80 toward the bulkhead 28 to provide seating locations that may be disposed outside the cabin 22. Alternatively or in addition, cargo may be stored between the rear wall 56 and the bulkhead 28.

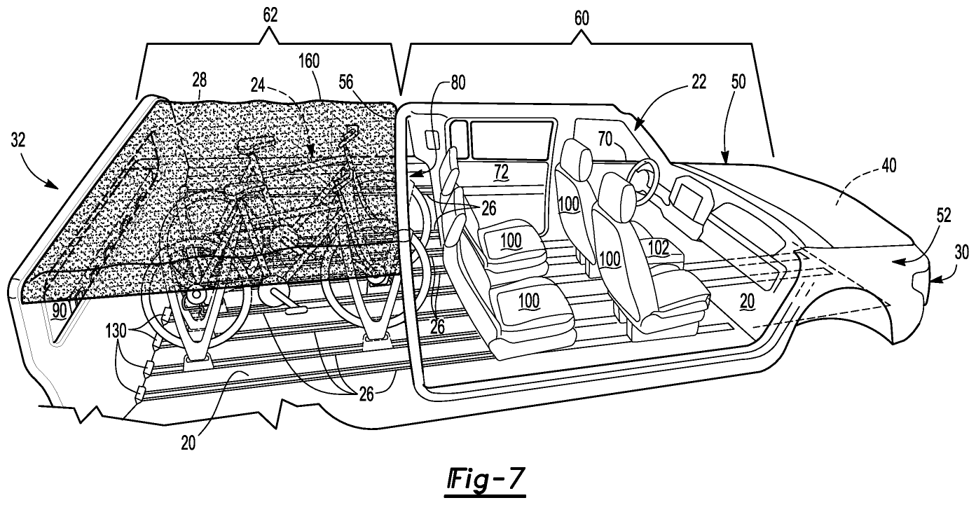

Referring to FIG. 7, a configuration is shown that is similar to the configuration shown in FIG. 6. A flexible cover 160 may extend from the bulkhead 28 to a part of the vehicle 10 that may define the cabin 22, such as the front portion 60 of the first lateral side body structure 50, the front portion 60 of the second lateral side body structure 52, the roof 54, the rear wall 56, or combinations thereof. The flexible cover 160 may be configured to expand, stretch, unfold, unroll, or bend when the bulkhead 28 is moved away from the rear wall 56 and toward the rear end 32 of the vehicle 10, thereby helping cover or enclose the region of the bed area 24 that is disposed between the bulkhead 28 and the rear wall 56.

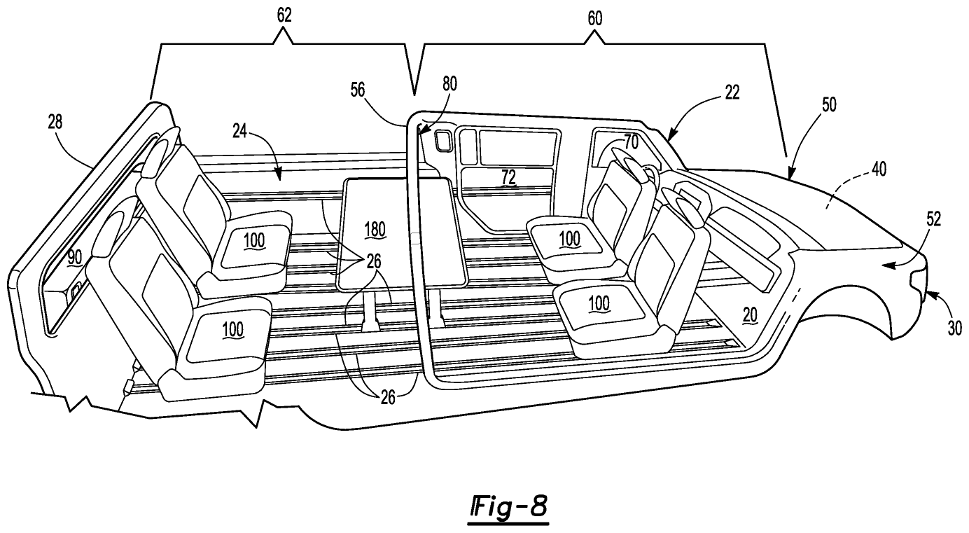

Referring to FIG. 8, a configuration is shown that is also similar to the configuration shown in FIG. 6. The bulkhead 28 is again positioned rearward of the rear wall 56. In addition, the rear vehicle seats 100 are depicted as being slid rearward through the opening 80 and out of the cabin 22 so that the rear vehicle seats 100 may be disposed in the bed area 24. The orientation of the front vehicle seats 100 has been changed so that the front vehicle seats 100 face toward the rear end 32 of the vehicle. The orientation of a front vehicle seat 100 may be changed in various ways. For instance, a front vehicle seat 100 may be disengaged from the guide rails 26 of the floor 20, removed from the guide rails 26, turned rearward, and then reengaged and remounted to the guide rails 26 of the floor 20. Alternatively, the front vehicle seats 100 may be rotatable to face rearward without decoupling from a guide rail 26. Occupants of the front vehicle seat 100 and occupants of the rear vehicle seat 100 may face toward each other in this configuration.

A table 180 may optionally be provided between the front vehicle seats 100 and the rear vehicle seats 100. The table 180 may be mountable to one or more guide rails 26. For instance, the table 180 may be mounted to a guide rail 26 that is provided with the floor 20, the first lateral side body structure 50, the second lateral side body structure 52 or combinations thereof. The table 180 may be mountable to a guide rail 26 that is provided with the first lateral side body structure 50, the second lateral side body structure 52, or both, thereby providing more space underneath the table 180 as compared to a configuration in which the table 180 is mounted to a guide rail 26 of the floor 20.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle comprising:
a floor that extends between a front end and a rear end of the vehicle;
a first lateral side body structure that extends from the floor, the first lateral side body structure including a door;
a second lateral side body structure that is spaced apart from and disposed opposite the first lateral side body structure, wherein the second lateral side body structure extends from the floor;
a roof that is spaced apart from and disposed opposite the floor, wherein the roof extends from the first lateral side body structure to the second lateral side body structure;
a rear wall that extends from the first lateral side body structure to the second lateral side body structure and that is longitudinally positioned between the front end and the rear end of the vehicle, wherein the rear wall extends from the roof and cooperates with the floor to at least partially define an opening; and
a bulkhead that is receivable in the opening and that is moveably mounted to the floor, wherein the bulkhead is moveable along a longitudinal axis with respect to the rear wall, the longitudinal axis extending between the front end and the rear end of the vehicle, wherein the floor has a guide rail that extends longitudinally and the bulkhead is moveably coupled to the guide rail of the floor and a front seat is mounted to the guide rail of the floor.

2. The vehicle of claim 1 wherein the bulkhead is moveable out of the opening.

3. The vehicle of claim 1 wherein the bulkhead is moveable through the opening toward the front end of the vehicle and toward the rear end of the vehicle with respect to the rear wall.

4. The vehicle of claim lclaim 8 wherein the floor has a guide rail that extends longitudinally and the bulkhead is moveably coupled to the guide rail of the floor.

5. The vehicle of claim 4 wherein the guide rail extends between the front end of the vehicle and a tailgate that is disposed proximate the rear end of the vehicle.

6. The vehicle of claim 4 wherein a front seat is mounted to the guide rail of the floor.

7. The vehicle of claim 1 wherein the first lateral side body structure has a guide rail that extends longitudinally, wherein the bulkhead is moveably coupled to the guide rail of the first lateral side body structure.

8. A vehicle comprising:
a floor that extends between a front end and a rear end of the vehicle;
a first lateral side body structure that extends from the floor, the first lateral side body structure including a door;
a second lateral side body structure that is spaced apart from and disposed opposite the first lateral side body structure, wherein the second lateral side body structure extends from the floor;
a roof that is spaced apart from and disposed opposite the floor, wherein the roof extends from the first lateral side body structure to the second lateral side body structure;
a rear wall that extends from the first lateral side body structure to the second lateral side body structure and that is longitudinally positioned between the front end and the rear end of the vehicle, wherein the rear wall extends from the roof and cooperates with the floor to at least partially define an opening; and
a bulkhead that is receivable in the opening and that is moveably mounted to the floor, wherein the bulkhead is moveable along a longitudinal axis with respect to the rear wall, the longitudinal axis extending between the front end and the rear end of the vehicle;
wherein the first lateral side body structure has a guide rail that extends longitudinally, wherein at least a portion of the guide rail of the first lateral side body structure is provided with the door and the bulkhead is moveably coupled to the guide rail of the first lateral side body structure.

9. The vehicle of claim 8 wherein the door is moveable between an open position and a closed position, wherein the door is disposed in the closed position and is not moveable to the open position when the bulkhead is aligned with the door.

10. The vehicle of claim 8 wherein the door is a rear door that is positioned longitudinally rearward from a front door.

11. The vehicle of claim 7 wherein the guide rail of the floor and the guide rail of the first lateral side body structure extend through the opening and into a bed area of the vehicle that is disposed between the rear wall and the rear end of the vehicle.

12. The vehicle of claim 11 wherein the bulkhead is moveable along the longitudinal axis through the opening and toward the front end of the vehicle with respect to the rear wall to extend an effective length of the bed area.

13. The vehicle of claim 12 wherein the vehicle has a front vehicle seat and a rear vehicle seat that is disposed longitudinally rearward from the front vehicle seat, wherein the rear vehicle seat is decoupled from the vehicle before moving the bulkhead away from the rear wall and toward the front vehicle seat.

14. The vehicle of claim 1 wherein the bulkhead is pivotable with respect to the rear wall between a nominal position and a reclined position in which a top end of the bulkhead is longitudinally positioned further rearward than a bottom end of the bulkhead that is disposed opposite the top end.

15. The vehicle of claim 14 further comprising a flexible cover that extends from the rear wall to the bulkhead, wherein the flexible cover expands when the bulkhead is moved from the nominal position to the reclined position.

16. A vehicle comprising:
a floor that extends between a front end and a rear end of the vehicle;
a first lateral side body structure that extends from the floor, the first lateral side body structure including a door;
a second lateral side body structure that is spaced apart from and disposed opposite the first lateral side body structure, wherein the second lateral side body structure extends from the floor;
a roof that is spaced apart from and disposed opposite the floor, wherein the roof extends from the first lateral side body structure to the second lateral side body structure;
a rear wall that extends from the first lateral side body structure to the second lateral side body structure and that is longitudinally positioned between the front end and the rear end of the vehicle, wherein the rear wall extends from the roof and cooperates with the floor to at least partially define an opening; and
a bulkhead that is receivable in the opening and that is moveably mounted to the floor, wherein the bulkhead is moveable along a longitudinal axis with respect to the rear wall, the longitudinal axis extending between the front end and the rear end of the vehicle,
wherein the bulkhead is moveable along the longitudinal axis through the opening toward the rear end of the vehicle with respect to the rear wall such that the bulkhead is completely spaced apart from and does not extend from the roof when the bulkhead is moved out of the opening toward the rear end of the vehicle.

17. The vehicle of claim 16 wherein a seat is mounted on a side of the bulkhead that faces toward the front end of the vehicle.

18. The vehicle of claim 17 wherein the seat on the bulkhead is longitudinally positioned rearward of the rear wall when the bulkhead is disposed in a bed area of the vehicle.

19. The vehicle of claim 16 wherein a front seat of the vehicle is positionable to face toward the rear end and the bulkhead when the bulkhead is longitudinally positioned rearward of the rear wall.

20. The vehicle of claim 16 further comprising a flexible cover that extends from the rear wall to the bulkhead, wherein the flexible cover expands when the bulkhead is moved away from the rear wall and toward the rear end of the vehicle.
